(19) United States
(12) Patent Application Publication
(10) Pub. No.: US 2025/0097196 A1
(43) Pub. Date: Mar. 20, 2025

(54) SYSTEMS AND METHODS OF IMPLEMENTING CROSS DOMAIN SOLUTIONS

(71) Applicant: SKYWARD FEDERAL LLC, Colorado Springs, CO (US)

(72) Inventors: Matthew PETERS, Boston, MA (US); Cameron REESE, Colorado Springs, CO (US); Erick HAMANN, Colorado Springs, CO (US)

(21) Appl. No.: 18/467,667

(22) Filed: Sep. 14, 2023

(51) Int. Cl. H04L 9/40

(52) U.S. Cl. CPC H04L 63/0209; H04L 63/102; H04L 63/145

(57) ABSTRACT

A system is provided that allows for determining which one of multiple possible cross domain solutions (CDSs) is to be used to carry out a request to transfer a payload from one domain (e.g., a low-side security domain) to another domain (e.g., a high-side security domain).

### CROSS REFERENCE(S) TO RELATED APPLICATION(S)

Not applicable.

### TECHNICAL OVERVIEW

The technology described herein relates to securely transferring data between different security domains. More particularly, the technology described herein relates to automatically handling which one of multiple possible cross domain solutions to use when transferring data from one security domain to another.

### INTRODUCTION

Cross Domain Solutions (CDS) facilitate the transfer of information (such as electronic data) from one security domain to another. Such solutions can involve the use of software, hardware, or a combination in order to provide an interface that controls how data is moved (or whether it is moved) from one security domain to another. However, due to the special nature of CDSs they can be difficult to manage, implement, and use. Accordingly, it will be appreciated that new and improved techniques, systems, and processes are continually sought after in this and other areas of technology.

### SUMMARY

In certain example embodiments, a system is provided that allows for determining which one of multiple possible cross domain solutions (CDSs) can be used to carry out a request to transfer a payload from one domain (e.g., a low-side security domain) to another domain (e.g., a high-side security domain). The system provides a unified interface and enables multiple possible different CDSs to be used—while also automatically handling various pre-processing tasks for each of the various possible CDSs.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is an architecture diagram of the systems used to handle transfer of data across different domains according to certain example embodiments;

FIGS. 2-5 is a flow chart of a process for how requests for transferring data from a first domain to a second domain may be implemented according to certain example embodiments;

FIG. 6 is a flow chart of a process for how data transferred to a second domain from a first domain may be implemented according to certain example embodiments;

FIG. 7 is a flow chart of a process showing how requests to view transfers from a first domain to a second domain may be implemented according to certain example embodiments;

FIG. 8 is a flow chart of a process showing how requests to retrieve the data that has been transferred from a first domain to a second domain may be implemented according to certain example embodiments; and

FIG. 9 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

In certain example embodiments, a system is provided that allows for determining which one of multiple possible cross domain solutions (CDSs) are to be used in attempting to carry out a request to transfer a payload from one domain (e.g., a low-side security domain) to another domain (e.g., a high-side security domain). The system provides interfaces to multiple possible different CDSs. When a request to transfer a payload is received, the system automatically generates a list of possible CDSs that can be used to carry out the transfer for that payload from the current domain to a requested domain. The list may be generated based on characteristics (e.g., metadata) of the payload, data of the request (e.g., the source and destination domain, the classification of such domains, etc.), and characteristics of the requestor for the transfer (e.g., the permissions associated with the requestor). The system then automatically manages the transfer of the payload from a first domain to a second domain. In the event that a transfer using a first selected CDS fails, the system automatically manages retrying the transfer with another CDS selected from the generated list. In certain example embodiments, pre-processing is performed on the payload. The preprocessing may include the generation of metadata for the payload, executing antivirus scans on the payload, executing deep-malware analysis (e.g., if the payload includes an executable), and/or cryptographically signing the transfer. Additional details are described in further detail below.

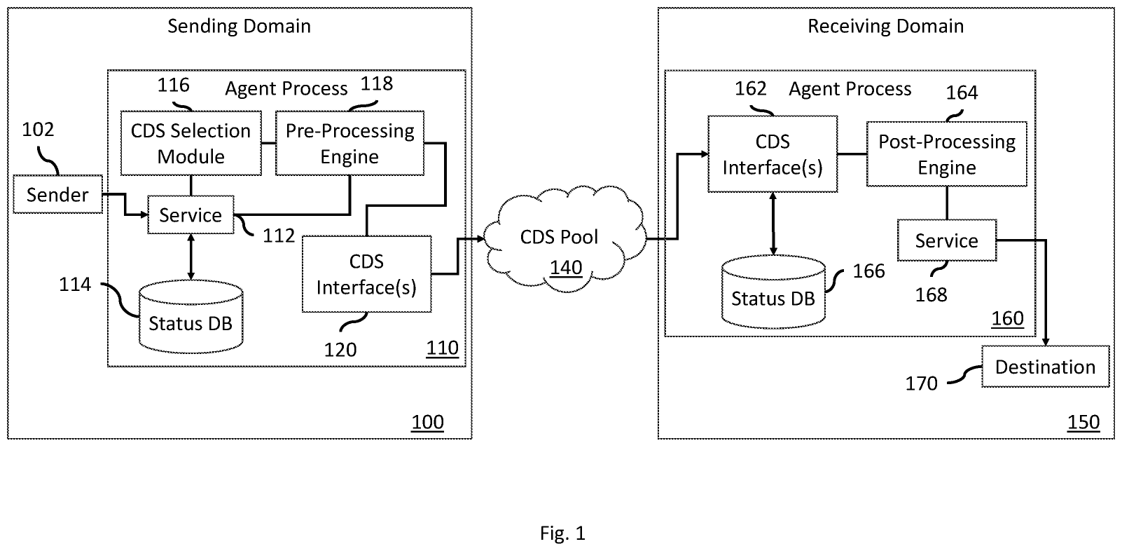

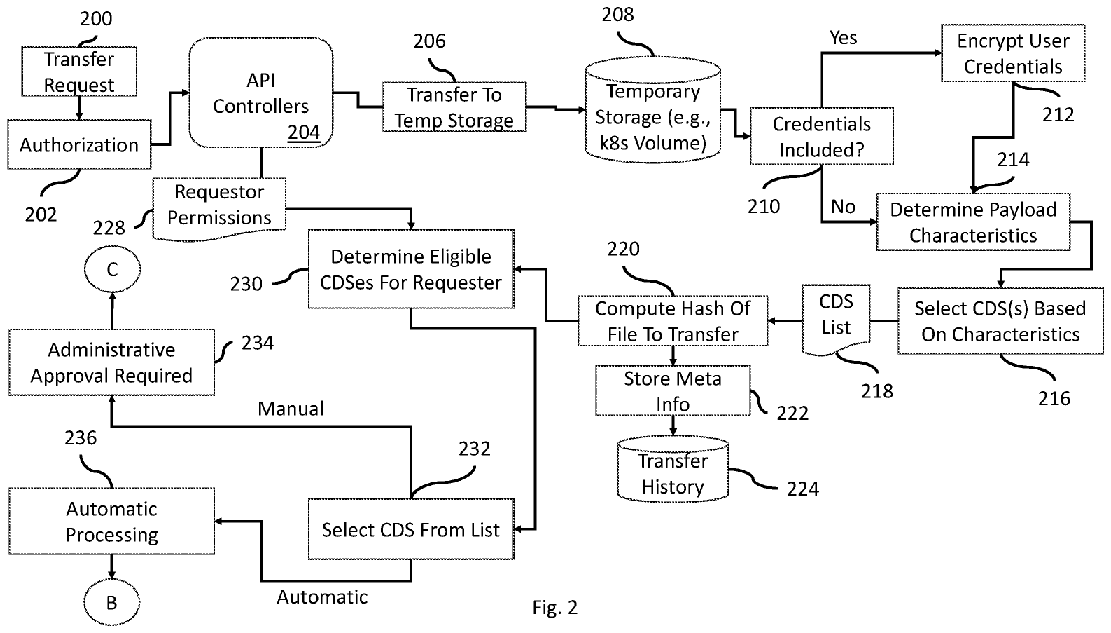

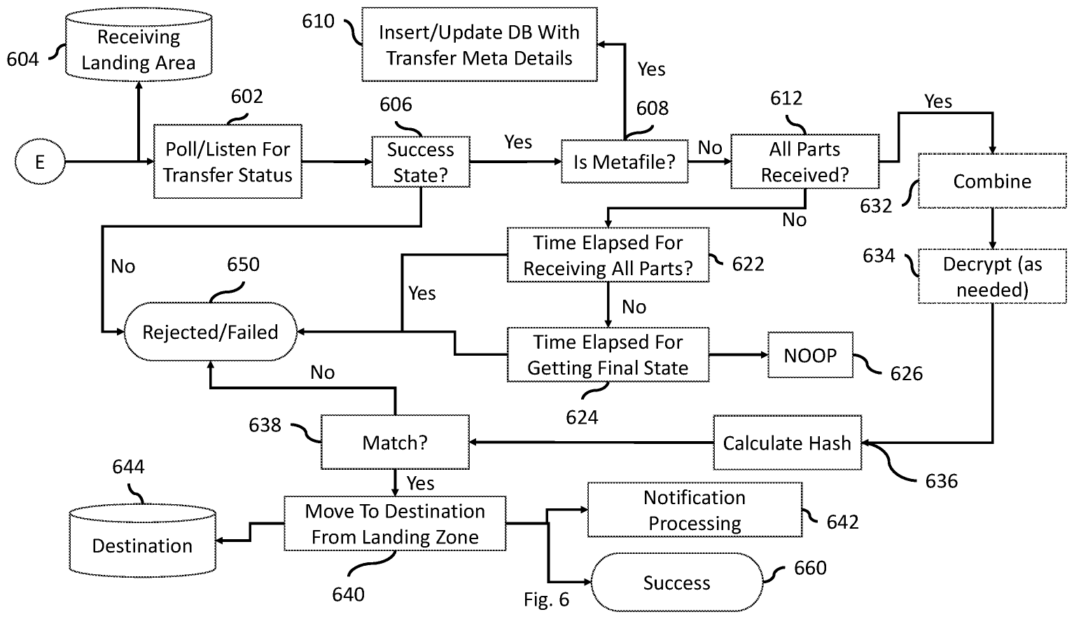

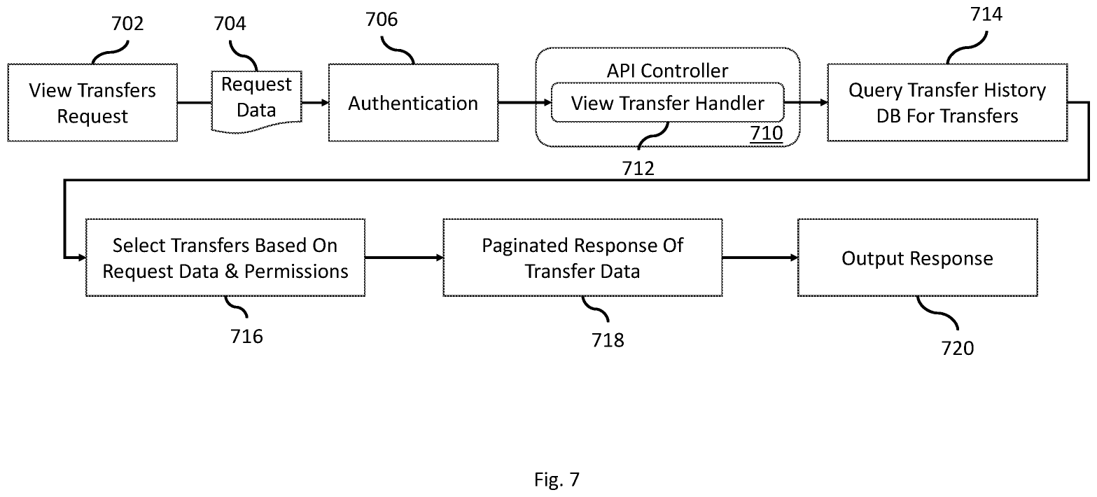

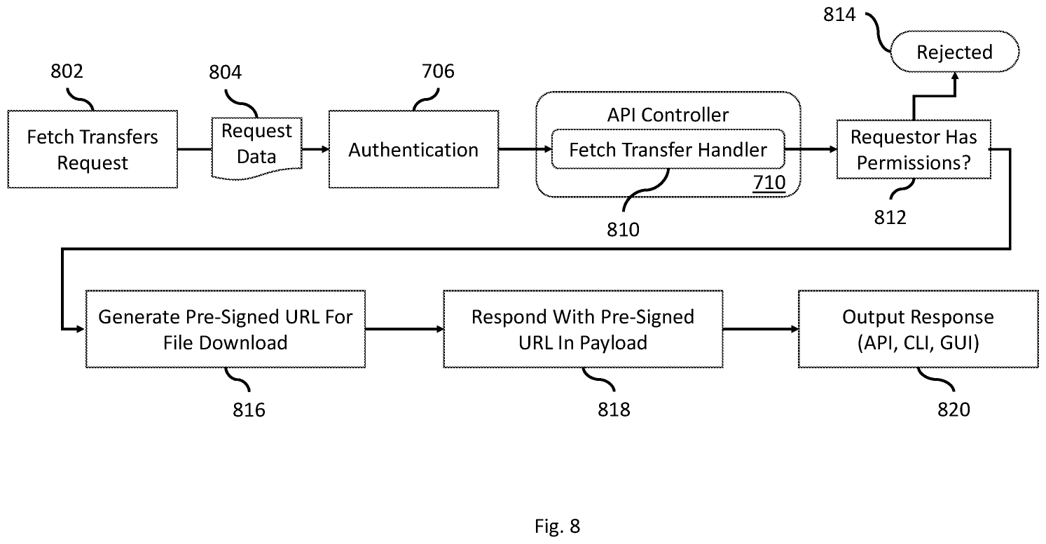

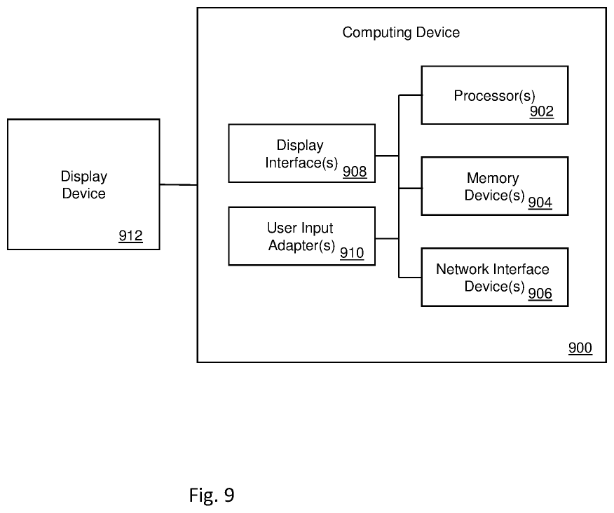

FIG. 1 is an architecture diagram of a system for transferring payloads between different domains according to certain example embodiments. FIGS. 2-5 is a flow chart that illustrates how a request to transfer a payload may be implemented according to certain example embodiments. FIG. 6 is a flow chart that illustrates how payloads are handled once transferred to a receiving domain according to certain example embodiments. FIGS. 7-8 illustrate how statuses or payloads can be viewed or retrieved according to certain example embodiments. FIG. 9 shows an example computing device that may be used in some embodiments to implement features described herein.

In many places in this document, software (e.g., modules, software engines, services, applications and the like) and actions (e.g., functionality) performed by software are described. This is done for ease of description; it should be understood that, whenever it is described in this document that software performs any action, the action is in actuality performed by underlying hardware elements (such as a processor and a memory device) according to the instructions that comprise the software. Such functionality may, in some embodiments, be provided in the form of firmware and/or hardware implementations. Further details regarding this are provided below in, among other places, the description of FIG. 9.

### Description of FIG. 1

FIG. 1 is an architecture diagram showing how data may be transferred across different domains according to certain example embodiments.

The architecture shown in FIG. 1 enables a sender 102 to request data be transferred from a sending domain 100 to a receiving domain 150. The data that is transferred may be delivered to destination 170. Domains 100 and 150 may be called security domains herein. Such domains may be unclassified (U), secret(S), top secret (TS) or the like. The domains may be provided within a cloud-based hosting service (e.g., AWS, Azure, etc.) or may be dedicated network/computing infrastructure. In certain examples, a security domain will include at least one computing device (e.g., one or more instances of the computing device discussed in FIG. 9), networking infrastructure, and/or one or more hardwired connections to one or more cross domain solutions (CDS).

Data that is transferred from one domain to another domain may be referred as a payload herein. A payload may be any type of data stored on an electronic information system, such as documents, executable files, database, containers (e.g., docker containers), and other information. Other data, such as a metadata of the payload may also be transferred.

The sender 102 may be a user that has authenticated to the sending domain. In some examples, the sender is a computer process (e.g., a computer service) or the like that is responsible for requesting the transfer for a payload from the sending domain 100 to the receiving domain 150. As an illustrative example, the sender may be part of a build process for software that conducts and automated build and then requests transfer of the software product that has been built.

Destination 170 may also be a user, a computer process, or a storage location that is part of the receiving domain. In some examples, the destination 170 may be, for example, an email or the like (e.g., delivery of an email). In some examples, destination 170 may be a cloud storage location (e.g., an S3 bucket or the like).

Communication of payloads between the two domains is handled by one of a plurality of CDSs that are provided in a pool of CDSs 140. Each domain includes an agent process (110/160) that functions as an interface layer between the CDS that handles the transfer and the sender/destination.

In the case of the sending domain 100, an agent process 110 is present to handle requests to transfer payloads from senders to the receiving domain 150. The agent process 110 includes a service 112, a CDS selection module 116, a pre-processing engine 118, a collection of CDSs interfaces 120, and a status database 114. The functionality that may be provided by the agent process 110 is discussed in connection with the processing shown in FIGS. 2-5 below.

Service 112 may be the entry point (e.g., API) for any requests that request a transfer. Examples of the service 112 include API controllers 204 of FIG. 2, and API controller 710 in FIG. 7 (which may be the same as the API controller of FIG. 2). Service 112 may handle, for example, authentication or authorization and other tasks. Service 112 may flexibly provide for different requestors to integrate with the agent service. Such requestors may use web and desktop apps, command line interface tools, or direct calls of the API that may be exposed for the service 112.

Service 112 interfaces with CDS selection module 116 that is responsible for selecting which CDS to use for the requested transfer of the payload. In some examples, the CDS selection module 116 may generate a list of CDSs to try. The processing may then iterate through the CDS in the generated list until a CDS successfully transfers the requested payload to the receiving domain.

Pre-processing engine 118 is responsible for handling the various pre-processing requirements of the diverse set of CDSs that may be called on to carry out the transfer to the receiving domain. In some examples, the CDSs may have different preprocessing requirements. For example, a CDS may require that the payload be subject to anti-virus scanning or the like. The pre-processing engine 118 may facilitate the automation of the processing that is required to use a given CDS from the pool of CDS 140.

CDS interfaces 120 are provided to prepare the payload as required for the selected CDS. Each interface in the collection of CDS interfaces 120 may invoke or communicate a corresponding CDS within the CDS pool 140. Once the pre-processing and other associated tasks are complete for a given CDS that has been selected, then the interface to a selected CDS may be invoked via the appropriate interface. The payload and any other data may be passed to the selected CDS (or placed into a storage location that the selected CDS can access/read from) to attempt to handle the transfer to the receiving domain.

In certain examples, each or any component of the agent process (110/160) may be implemented within one or more own computer processes or threads. In certain examples all processing performed within the agent process (110/160) is provided within a single process and/or single thread.

It will be appreciated that certain CDSs may have strict requirements for how the payload that is to be transferred is prepared and/or formatted. The processing described in FIG. 2-5 allows for making use of many different types of CDSs—without requiring each user know the specific nature of how to prepare the payload to be used by a given CDS.

The agent process 110 also includes or has access to a status database 114. This database is used to store the status and/or history of transfers. This database may store all transfers including attempted (and failed) transfers, in-progress transfers, and completed transfers that are performed to/from the domain.

The CDSs that are included in the CDS pool 140 may use software, firmware, hardware, or a combination thereof to transfer a payload from the sending domain 100 to the receiving domain 150. In some examples, the CDS may be implemented using one or more field programmable gate array (FPGA).

In some examples, the receiving domain 150 may be (and typically will be) a higher security domain than the sending domain. However, in other examples, the receiving domain 150 may be of the same or lower security classification.

The receiving domain 150, like sending domain 110, includes an agent process 160, which may be the same or similar to agent process 110. In some examples, the agent process 160 may be the same as agent process 110 and thus provides transmission and reception functionalities. In other examples, agent process 160 may only include reception functionality. Transmission functionality may be provided separately or not at all to the receiving domain in certain examples.

The agent process 160 includes CDS interfaces 162, a post-processing module 164, and service 168. The agent process 160 also may include, or have access to, a status database 166.

CDS interfaces 162 are responsible for receiving and handling the payload communicated to the receiving domain 150 via the selected CDS. The CDS interfaces 162 may be tailored to the specific CDS that is handling the transfer, may be generic, or implement standard inference requirements. In some examples, the CDS interfaces may monitor specific storage (e.g., disk, memory, cache, etc.) locations for when transfers are communicated from a given CDS to the receiving domain 150.

Post-processing module 164 is responsible for one or more post-processing operations that occur after a payload has been transferred to the receiving domain 150. This may include, for example, calculating hashes, combining parts of payload (e.g., if the payload was split into multiple transfers), and/or other operations.

Service 168 is responsible for delivering the resulting payload to the destination 170. For example, service 168 may cause the generation of an email that includes a secure download link, or the like. It will be appreciated that delivery of a payload by a CDS to the receiving domain may not include notifying users and/or processes. Accordingly, service 168 provides an interface for handling such notifications.

Status database 166 stores the status of incoming transfers—both those that are in progress and those that have been completed. This database may store all transfers including attempted (and failed) transfers, in-progress transfers, and completed transfers and may thus provide a history of transfers that have occurred both to the current domain and out of the current domain.

In some examples, the status database (114/166) may be queried by a user or service to determine the status of a transfer or see all transfers associated with the specific user. This is discussed in connection with FIG. 7.

### Description of FIGS. 2-5

FIGS. 2-5 is a flow chart of a process for how requests for transferring data from a first domain to another domain may be implemented according to certain example embodiments.

At 200, a request to transfer a payload from a first domain to a second domain is initiated. The transfer request can be performed via an API call, a command line interface, a GUI (e.g., a web page or thick client, etc.), or the like.

At 202, the request to transfer the payload is authenticated. In some examples, this may include retrieving a session token or interfacing with an identity service. The permissions associated with this request and/or entity (e.g., the user/account/etc.) making the request are then delivered to the API controller 204.

At 206, the payload that is the subject of the transfer is moved to temporary storage at 208. In some examples, the temporary storage may be a local or network volume. In some examples, the temporary storage may be a K8s volume that is generated for this payload/transfer. The payload may be transferred to the temporary storage using one of a plurality of different possible options. These include a direct upload in which the payload is written to storage as it is received from the requestor. Another transfer option may be fetching the payload from another source. For example, the payload may be located in an S3 volume (e.g., if Amazon's AWS is being used). In such a case the payload may be fetched using an S3 URI via AWS's SDK using the credentials/token retrieved via 202. Another transfer option may be a URL fetch in which the payload is fetched from a URL that is provided as part of the request. In any event, the payload is written to temporary file storage 208.

Next, at 210, the process determines if the request includes credentials (e.g., a password or other credentials). If such credentials were included, then they are encrypted at 212. If no such credentials were included, then the process proceeds directly to 214.

At 214, the process checks the characteristics of the payload. This may include determining the size (e.g., how many kilobytes, megabytes, etc.), type (e.g., whether a data file or an executable file), number of archived layers, if the payload is encrypted, other types of file/payload metadata, etc.

At 216, a list 218 of CDSs that can be used for this payload is compiled. The list is generated based on the characteristics of the payload that are determined at 214. In certain examples, the list is generated with an order in which the listed CDSs are to be attempted. In other words, 216 may generate both the list of CDSs and an order in which those CDSs are to be attempted to carry out the transfer. The ordering of the CDSs within the list will be used if one or more CDSs fail in transferring the payload.

In certain example embodiments, a priority list of CDSs that may be used in connection with a given security domain (e.g., those in the CDS pool 140) may be defined independent of a given request to transfer a specific payload. Such a priority ranking may also be used to determine an ordering of the CDS within the list that is generated.

In certain example embodiments, a generic CDS that functions to generate the payload as described herein may be used. However, this generic CDS may not be used to transfer a given payload to another domain. Rather, once the pre-processing and associated steps are completed (as described in connection with FIGS. 2-5), then the resulting file/payload (including a generated manifest in certain examples) may be stored to a location (on the sending domain or other location that does not require using a CDS for transferring) so that the requestor can obtain the payload and deliver the payload as required (e.g., manually such as via hard copy such as a CD, etc.). In certain examples, the generic CDS may be used instead of interfacing with one of the CDSs in the pool. The payload may then be delivered, manually placed into the second security domain, which may then perform the post-processing and other operations discussed herein.

In certain example embodiments, the CDSs included in the list and/or selected to be included in the list are selected according to the least restrictive restrictions available. In other words, a CDS that has less restrictions will be prioritized ahead of a more restrictive CDS. In other examples, the order may be performed in reverse (e.g., with the most restrictive CDS used first). In other examples, there may be additional or different logic in connection with preparing the list of CDSs to use. As an illustrative example, if there are 3 CDSs, 2 of which have preprocessing requirements (X) and each have file characteristic allowances of (A, B) and (A, B, C) respectively, and the 3rd has preprocessing requirements (X, Y, Z) but allows for file characteristics (A, B, C, D, E) then the first two are prioritized in sort order above the 3rd because they are least restrictive in their preprocessing requirements, but are more restrictive in what file characteristics are allowed. Then a sub sort of the 2 CDSs is as follows: one of the CDSs only allows file characteristics (A, B) and the other CDS allows file characteristics (A, B, C) the sort order for which CDS it will try is (A, B, C) and then the (A, B) one then, so it is sorted on least restrictive.

With the list 218 generated, at 220, a hash of the payload is generated. The hash and any other metadata related information (e.g., the payload characteristics, the permissions associated with the request, etc.) for the payload are stored at 222 to a transfer history database 224. The transfer history database 224 may be an example of the status database 114 discussed in FIG. 1.

As discussed in connection with FIGS. 7-8, the transfer history database 224 is maintained in order to provide an audit trail and is queryable at a later point in time to see the status/history of requested payload transfers.

When the authorization data for the request that is making the request is retrieved, the permissions available to that requestor 228 are passed to 230 to determine which of the possible CDSs the requestor may be eligible for using. In other words, the type of payload that is being transferred may be supported by (for example) 10 different CDSs, but the requestor may only have authorization to use 2 of the CDSs included in the list. In some examples, the permissions may be used to determine which CDSs can be used by the requestor without requiring manual authorization from another user (e.g., an administrator). In some examples, the list may be generated (at 216) based on the permissions associated with the requestor.

At 232, a CDS from the list generated at 216 is selected to carry out the transfer. As noted above, the list may be ordered and accordingly, the CDS selected at 232 may be the CDS at the top of the list. However, if the requestor associated with this particular transfer is not authorized to use a given CDS, then that CDS may be skipped and the next CDS that the requestor is authorized to use may be selected.

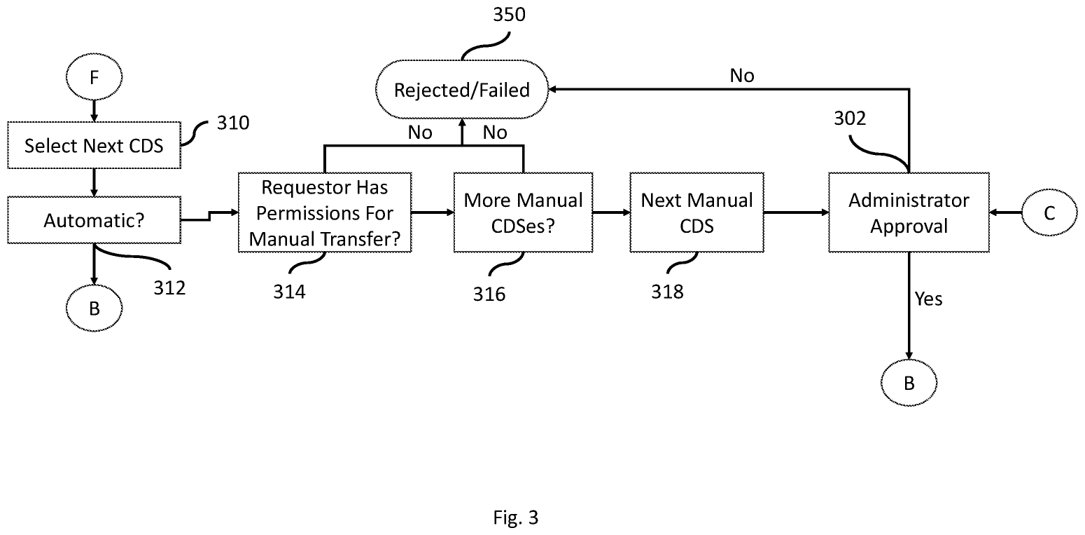

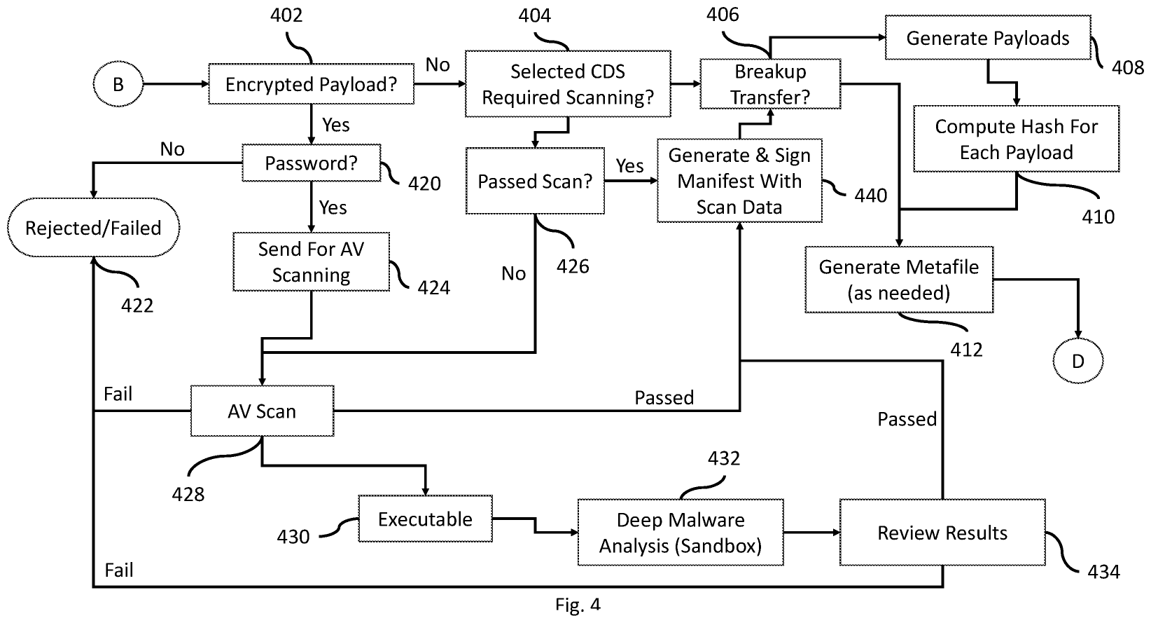

If the selected CDS requires manual approval from an administrator, then the process proceeds to 234 and C, which is discussed in FIG. 3. But, if the selected CDS is to be automatically executed (e.g., without manual approval), then the processing at 236 and B (in FIG. 4) is performed.

FIG. 3 illustrates aspects of the process that occur when administrator approval is required and/or another CDS needs to be used to attempt at carrying out the transfer.

From C, at 302, a manual requirement for authorization may be triggered. When this occurs, one or more administrators may be notified (e.g., via email or the like) at 302. If the administrator approves the transfer request, then the process moves to B (discussed in FIG. 3). If the administrator denies the transfer request, then the transfer is rejected at 350.

When a transfer fails for whatever reason, then, from F, the next CDS in the generated list (e.g., as generated from 216) is selected at 310. If the next CDS is one that can be automatically processed for this request, then the process moves to B. Note that in certain examples, a re-analysis of the metadata or characteristics of the payload is not performed. Rather, the next CDS in the already generated list is selected.

Next, at 314, if the next selected CDS is not automatic, then the process determines if the requestor has permissions (e.g., based on permissions 228) for a manual transfer. If the requestor does not, then the process moves to 350 and the request to transfer the payload is rejected.

If the requestor does have permissions (as specified in 228) for manual approval, then the process determines, at 316, if there are any more CDS that can use manual approval. If there are none, then the process moves to 350 and the request to transfer the payload is rejected. If there are additional CDSs that can use manual approval, then the next manual CDS is selected at 318 and approval is then requested at 302. If approval is granted, the process moves to B and FIG. 3. Otherwise, the request is rejected at 350.

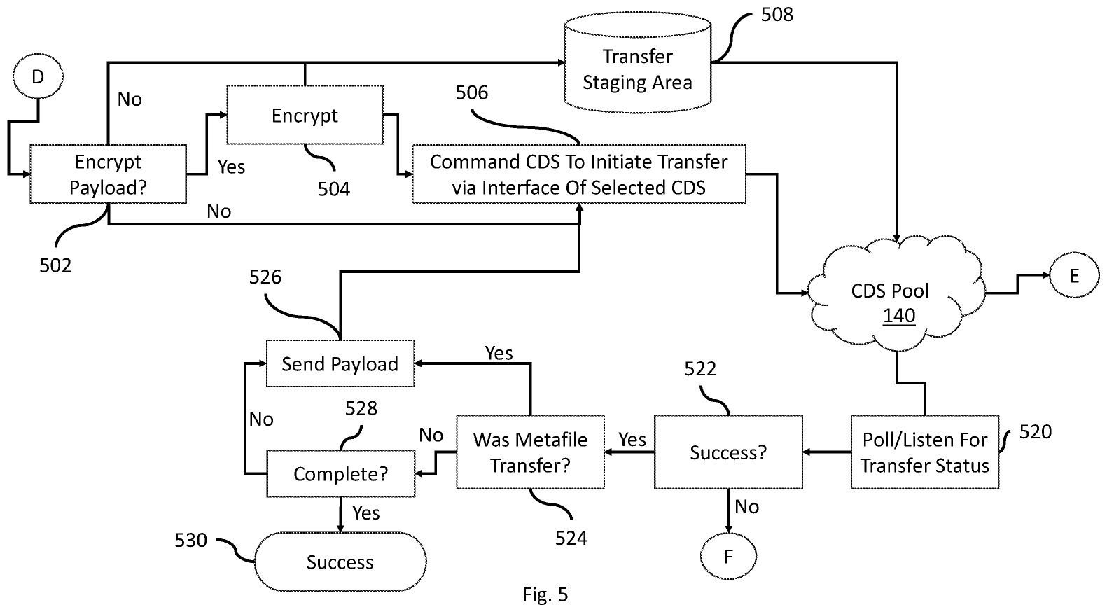

Turning now to FIGS. 4 and 5, the pre-preprocessing operations for the selected CDS are performed.

At 402, the process determines if the payload is encrypted. If the payload is encrypted, then at 420 the process retrieves the password that is used to decrypt the payload. If no password has been provided, then the transfer of the payload fails at 422.

If a password has been provided, then the payload is decrypted using the password and an antivirus scan is performed on the payload at 428. In certain example embodiments, the AV scan is performed by a third-party service that is located either within or outside of the sending domain. If the AV scan indicates a failure, then the transfer of the payload fails at 422.

In some examples, if the AV scan fails, the process also then determines if the payload is an executable at 430, if so, then a deep-malware analysis of the executable is performed within a sandboxed environment at 432.

The results of the malware testing are provided for review at 434. In some examples, the review is performed by an administrator that either indicates passage of the malware check or failure. In other examples, automated processing may be performed on the malware results to determine passage or failure.

Returning to 404, if the payload is not encrypted, then at 404 the process determines if the selected CDS requires scanning. The scanning may be either in the form of AV scanning (e.g., 428) and/or scanning for malware (e.g., 432).

If no such scanning is required, then the process moves to 406, which is discussed below. If, however, scanning for the selected CDS is required for this payload, then the process determines if scanning has already been performed for this payload at 426. In other words, if the payload passed AV scanning for pre-processing for another CDS (which failed to complete transfer of the payload), then that prior scan for the payload may be used without having to rerun the AV scan and/or the deep malware analysis. This is because the payload remains the same.

If no such prior scanning had been performed, then the above discussed AV and/or malware scanning is performed.

At 440, a manifest is generated with the AV and/or malware scanning results and then cryptographically signed. In certain examples, such a manifest may be required by the currently selected CDS. Once the manifest is generated it may then be moved to a transfer staging storage area 508 that is used for the payload.

Turning back to 406, the process determines if the payload will be split into multiple sub-payloads. If such splitting is required, then the multiple payloads are generated at 408. A hash value is computed for each part at 410.

At 412 a metafile is generated for the payload. This may include a hash of the payload and/or each individual part of the payload (if multiple parts). Any attribute information for the payload, and possibly other information that may be used by the CDS to carry out the transfer. The process continues in FIG. 5 via D.

At 502, the process determines if the payload is to be encrypted. If the payload should not be encrypted, then the payload is moved to the transfer staging area 508.

If the payload is to be encrypted, then it is encrypted at 504 and the encrypted version is stored at the transfer staging area 508. In certain examples, the encryption that is used is a symmetric encryption, such as AES256. In such cases, the key for the encryption may be overwise delivered (e.g., hand delivered when the receiving system is setup or at another time period) to the receiving domain so as to be used for decryption.

Once the payload (whether encrypted or not) is ready at the staging area, then a command is communicated to the selected CDS in the CDS pool 140 (via the appropriate interface) to begin the transfer of the payload to the receiving domain. The process of receiving the payload is discussed in FIG. 6.

Once the command to initiate the transfer is given, the process polls or otherwise listens for the transfer status at 520. Note that in some instances, the CDS being used may not provide a status of requests. In such cases the acceptance of the transfer by the CDS causes the status for that transfer to be recorded as a non-fail state (e.g., it is assumed that the transfer succeeded).

If the received status indicates a failure at 522, then the process returns to F in FIG. 3 and the next CDS is selected at 310.

If, however, a success indication is received, then the process determines, at 524, if the success was for the metafile. In other words, the metafile that is generated at 412 may also be transferred by the CDS to the receiving domain. This file may be used to carry out the reception process by the agent process 160.

If the data that was transferred was the metafile, then at 526, the payload is sent. In other words, the metafile may be sent first, with the payload following.

If the successful transfer was not for a metafile, then the process determines if all parts of the payload have been transferred at 528. In other words, the payload may have been split into multiple parts. In such a case, the next sub-payload part may be sent at 526. This may be performed as the underlying CDS may only handle payloads of a certain size. However, with the techniques herein, the handling of larger payload sizes may be automatically handled by the techniques herein—while also still being able to leverage the functionality of the selected CDS.

If the transfer is determined to have been complete at 528, then the transfer is recorded as a success (e.g., in the transfer history database 224) at 530.

In connection with the features described in FIGS. 2-5, in certain examples, every payload that is processed by the agent will be scanned for viruses and/or malware. This will be accomplished even if the CDS that is selected does not require scanning (e.g., because the CDS itself will handle such processing).

In certain example embodiments, if a CDS requires a scan, the process will block until that scan is complete (e.g., at 428/404, etc.). If, however, the selected CDS does not require a scan in order to operate, then the process will not block. However, the scan (e.g., 428/432, etc.) will still occur within the agent process, but the process will proceed and submit the payload to the CDS for transferring. The results of the scan may then be stored within a database and be auditable at a later point in time. This processing may thus allow for the data to be sent through the CDS as quickly as possible.

In certain example embodiments, the data that is compiled for transfers may be used to train a model. The features to train the model may involve any the metadata regarding the payload, date/time information for the request, the user (including metadata about the user), the group the user is in, the CDS being used, the channel in which the CDS is being used, and the like. A machine learning model may be trained on these features to automatically recognize (e.g., as percentage chance) whether a requested transfer is “good” or “bad”. In certain example embodiments, when a trained model is used, a bad result may cause the process to block the transfer, or at least trigger a manual review. In certain example embodiments, a heuristic process may be used to carry out this analysis.

In certain example embodiments, the payload may be a virtual container or the like (e.g., docker container). In such cases, another type of scanning that may be used in certain examples may be a container scanner that scans the target container—and the dependencies in that container for any vulnerabilities.

### Description of FIG. 6

FIG. 6 is a flow chart of a process for how data transferred to a second domain from a first domain may be implemented according to certain example embodiments.

When a CDS transfers a payload, it may write the payload to a receiving or landing area 604. This can be a temporary storage location for the payload that is being transferred. As an illustrative example, in the case of AWS, the receiving area may be an S3 bucket that is provided as part of (or separate from) the receiving domain 160.

In connection with the transfer of the payload by the CDS, the process (e.g., that is performed by agent process 160) will poll or listen for a transfer status at 602. In some examples, the polling may be watching the landing area for when new data is transferred from a CDS in the CDS pool. In some examples, the process may poll, for example, a buffer of a network card or a specific location in memory. It will be appreciated that the way in which the data is delivered may depend on the CDS that is being used.

If the success state of the transfer indicates a failure at 606, then a rejected/failure status is recorded at 650. This information may be recorded to the status database 166 of the agent process 160.

If the success state of the transfer is positive at 606, then the process determines if the data transferred is for the metafile for the payload at 608. If the transferred data is a metafile, then that information is written to the status database at 610.

If the received data is not a metafile, then the process determines, at 612, if all parts for the payload have been received at 612.

If all of the parts of the payload have not been received, then the process proceeds to 622 and determines if a threshold time limit for receiving all payload parts has expired. If so, then the transfer is deemed to have failed at 650 and the status database accordingly updated. If the threshold for receiving all parts has not elapsed, then the process determines if a time threshold for obtaining the final state of the transfer has elapsed at 624. If so, then the transfer is deemed to have failed at 650 and the status database accordingly updated. If the time threshold for obtaining the final state of the transfer has not elapsed, then the process continues to pool/listen for transfers at 602. In other words, the process will continue to monitor for the succeeding transfers of the payload.

If all parts of a payload have been received (whether 1 or multiple), then the multiple parts are combined (if applicable) at 632.

Once the payload is recombined, then if the payload is encrypted (e.g., as indicated in the metafile), then it is decrypted at 634.

A hash of the resulting payload is calculated at 636 and then compared to the hash of the payload included in the metafile at 638. This hash comparison is used as an integrity check for the payload. Such processing can be performed to, for example, protect against man in the middle attacks that may occur during the transfer. Note that in certain examples, the hashes of individual parts may also be compared (e.g., as part of 632).

If the hashes do not match, then the transfer is deemed to have failed at 650 and the status database accordingly updated. If, however, the hashes do match, then, at 640, the payload is moved from the landing zone to a resulting destination 644. At 642, notification processing is performed, and the success of the transfer is recorded to the status database at 660.

Notifications may occur by using email or the like. In certain examples, prompts for users to retrieve a secure download link may be included in the email. Users may be required to authenticate to, agent process 160/110 to receive the link).

### Description of FIGS. 7-8

FIGS. 7 and 8 are flow charts for processes showing how requests to view/fetch transfers that occur from a first domain to a second domain may be implemented according to certain example embodiments.

FIG. 7 is a process that illustrates how a user can view the history of transfers that have occurred for the domain to which the request is being submitted. The process shown in FIG. 7 may be implemented in agent process 110 (as part of the service 112), in agent 160 (e.g., as part of service 168), or both. Accordingly, the request to view the transfers may provide a view of transfers from the current domain. Alternatively, the request may provide a list of transfers to the current domain. In some examples, the request may be used to show both (e.g., should a domain both send and receive transfers—such as from an unclassified domain and to a top-secret domain).

In any event, at 702, a request 704 is submitted to the agent to view transfers that have occurred for the instant domain. The request 704 may be provided from an API interface, a command line interface, a web (or other) graphic user interface client. The request may include characteristics of transfers to view (e.g., only transfers greater than a certain size, only transfers that involved executables, only transfers that involved a user or a group of users, etc.).

At 706, the requestor may be authenticated/authorized. This may include obtaining the permissions associated with the request (e.g., the level of permissions that are given to the request user or process).

The request is routed to an API controller 710 (e.g., part of service 112 or the like) and specifically the view transfer handler 712.

At 714, the view transfer handler 712 initiates a connection to the transfer history database that is part of the domain for which the request is submitted. View transfer handler 712 requests the database for all transfers that are associated with the request.

At 716, the results from the database are obtained. These results are filters to remove those requests for which the requestor does not have permissions to view (based on the permissions obtained in connection with the authorization).

At 718 a paginated response of the list of transfers that satisfy the request (and the permissions of the requestor) are returned as a response payload.

At 720, the response is output to the user. The response may be output to a command line, a GUI client, or an API. The response may be provided to any (or all) of these outputs based on which interface initiated the request.

In addition to viewing transfers, requestors may also fetch previously provided transfers. As an example, a user can fetch a transfer that has arrived at a receiving domain or may fetch a transfer that was sent from a sending domain. FIG. 8 is a flow chart of a process showing how requests to fetch transfers may be implemented according to certain example embodiments.

At 802 a fetch request is formulated. As with 702 the request may come from a user or an automated process. The request may be initiated via an API call, a GUI action, or a CLI client. In some examples, the fetch request may be initiated based on a collection of transfers that have been provided via the process shown in FIG. 7. For example, a list of transfers may be returned to a user. The user may then select one via a GUI to then fetch.

The request will include request data 804. Typically, the request data 804 will identify a single transfer (e.g., by a GUID/path or the like). However, in certain example embodiments, multiple transfers may be identified or conditions in which multiple transfers are to be fetched.

Authentication and/or authorization is performed at 706 for the request and the permissions associated with the requestor are obtained for this request. The request is handled by the fetch transfer handler 810 of the API controller 710.

At 812, the process determines if the requestor has permission (based on the retrieved permissions for the requestor from 706) to make this request. If not, the request is rejected at 814.

If the requestor is authorized to fetch the indicated payload, then a pre-signed URL is generated to facilitate download of the payload at 816. That is then communicated to the requestor at 818 where the output is then provided at 820.

If the request is to be delivered to an API, then a JSON payload (or similar) may be provided with the pre-signed URL included in the response.

If the response is provided to a CLI tool or a GUI tool, then the JSON payload (or similar) may be provided with the pre-signed URL included in the response. The CLI/GUI tool may be configured to download the file or present the response as part of the CLI/GUI tool (e.g., if the payload is text or the like). If the payload is to be downloaded, then the payload is downloaded from the pre-signed URL and saved to a location on disk.

### Description of FIG. 9

FIG. 9 is a block diagram of an example computing device 900 (which may also be referred to, for example, as a “computing device,” “computer system,” or “computing system”) according to some embodiments. In some embodiments, the computing device 900 includes one or more of the following: one or more processors 902 (which may be referred to as “hardware processors” or individually as a “hardware processor”); one or more memory devices 904; one or more network interface devices 906; one or more display interfaces 908; and one or more user input adapters 910. Additionally, in some embodiments, the computing device 900 is connected to or includes a display device 912. As will explained below, these elements (e.g., the processors 902, memory devices 904, network interface devices 906, display interfaces 908, user input adapters 910, display device 912) are hardware devices (for example, electronic circuits or combinations of circuits) that are configured to perform various different functions for the computing device 900. In some embodiments, these components of the computing device 900 may be collectively referred to as computing resources (e.g., resources that are used to carry out execution of instructions and include the processors (one or more processors 902), storage (one or more memory devices 904), and I/O (network interface devices 906, one or more display interfaces 908, and one or more user input adapters 910). In some instances, the term processing resources may be used interchangeably with the term computing resources. In some embodiments, multiple instances of computing device 900 may be arranged into a distributed computing system.

In some embodiments, each or any of the processors 902 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 902 uses an instruction set architecture such as x86 or Advanced RISC Machine (ARM).

In some embodiments, each or any of the memory devices 904 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 902). Memory devices 904 are examples of non-transitory computer-readable storage media.

In some embodiments, each or any of the network interface devices 906 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), LTE Pro, Fifth Generation New Radio (5G NR) and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, data is communicated over an electronic data network. An electronic data network includes implementations where data is communicated from one computer process space to computer process space and thus may include, for example, inter-process communication, pipes, sockets, and communication that occurs via direct cable, cross-connect cables, fiber channel, wired and wireless networks, and the like. In certain examples, network interface devices 906 may include ports or other connections that enable such connections to be made and communicate data electronically among the various components of a distributed computing system.

In some embodiments, each or any of the display interfaces 908 is or includes one or more circuits that receive data from the processors 902, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 912, which displays the image data. Alternatively, or additionally, in some embodiments, each or any of the display interfaces 908 is or includes, for example, a video card, video adapter, or graphics processing unit (GPU).

In some embodiments, each or any of the user input adapters 910 is or includes one or more circuits that receive and process user input data from one or more user input devices (not shown in FIG. 9) that are included in, attached to, or otherwise in communication with the computing device 900, and that output data based on the received input data to the processors 902. Alternatively, or additionally, in some embodiments each or any of the user input adapters 910 is or includes, for example, a PS/2 interface, a USB interface, a touchscreen controller, or the like; and/or the user input adapters 910 facilitates input from user input devices (not shown in FIG. 9) such as, for example, a keyboard, mouse, trackpad, touchscreen, etc.

In some embodiments, the display device 912 may be a Liquid Crystal Display (LCD) display, Light Emitting Diode (LED) display, or other type of display device. In embodiments where the display device 912 is a component of the computing device 900 (e.g., the computing device and the display device are included in a unified housing), the display device 912 may be a touchscreen display or non-touchscreen display. In embodiments where the display device 912 is connected to the computing device 900 (e.g., is external to the computing device 900 and communicates with the computing device 900 via a wire and/or via wireless communication technology), the display device 912 is, for example, an external monitor, projector, television, display screen, etc.

In various embodiments, the computing device 900 includes one, or two, or three, four, or more of each or any of the above-mentioned elements (e.g., the processors 902, memory devices 904, network interface devices 906, display interfaces 908, and user input adapters 910). Alternatively, or additionally, in some embodiments, the computing device 900 includes one or more of: a processing system that includes the processors 902; a memory or storage system that includes the memory devices 904; and a network interface system that includes the network interface devices 906. Alternatively, or additionally, in some embodiments, the computing device 900 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processors 902 and the network interface devices 906; or the single SoC (or the multiple SoCs) may include the processors 902, the network interface devices 906, and the memory devices 904; and so on. The computing device 900 may be arranged in some embodiments such that: the processors 902 include a multi or single-core processor; the network interface devices 906 include a first network interface device (which implements, for example, WiFi, Bluetooth, NFC, etc.) and a second network interface device that implements one or more cellular communication technologies (e.g., 3G, 4G LTE, CDMA, etc.); the memory devices 904 include RAM, flash memory, or a hard disk. As another example, the computing device 900 may be arranged such that: the processors 902 include two, three, four, five, or more multi-core processors; the network interface devices 906 include a first network interface device that implements Ethernet and a second network interface device that implements WiFi and/or Bluetooth; and the memory devices 904 include a RAM and a flash memory or hard disk.

The hardware configurations shown in FIG. 9 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 9, (e) via other hardware arrangements, architectures, and configurations, and/or via combinations of the technology described in (a) through (e).

### Technical Advantages of Described Subject Matter

In certain example embodiments, the system and the techniques discussed herein provide for a common layer that allows users (and organizations) to quickly leverage and adopt additional (e.g., new) CDSs to both existing and new environments. The common interface can provide users with a more consistent experience in carrying out the transfer for payloads between different security domains that use a CDS for such transfers.

In certain example embodiments, the system and the techniques discussed herein provide for automatically selecting an appropriate CDS to carry out a transfer between security domains. In certain example embodiments, when a CDS is selected, the pre-processing tasks for using that particular CDS for transferring the requested payload are automatically performed.

The techniques herein allow for software to be created in one security domain (e.g., a low side), and then have that software securely transferred to a high side domain. This may be used as part of a continuous integration and continuous deployment (CI/CD) pipeline for software that is used in high secure domains.

### Selected Terminology

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Whenever it is stated herein that a hardware element (e.g., a processor, a network interface, a display interface, a user input adapter, a memory device, or other hardware element), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can therefore be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

### Additional Applications of Described Subject Matter

Although process steps, algorithms or the like, including without limitation with reference to FIGS. 2-8, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above descriptions should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A system that interfaces with a plurality of cross domain solutions (CDS), the system comprising:
a processing system that is provided within a first security domain, the processing system comprising instructions stored to non-transitory memory, the instructions configured to cause at least one hardware processor of the first processing system to perform operations comprising:
receiving a request to transfer a payload from the first security domain to a second security domain;
extracting metadata based on the payload;
automatically selecting, based at least in part on the extracted metadata, a first CDS, out of a plurality of CDSs, to carry out the transfer of the payload from the first security domain to the second security domain;
based on which one of the plurality of CDSs was selected as the first CDS, performing one or more preprocessing operations on the payload; and
based at least in part on the performed one or more preprocessing operations, instructing the first CDS to transfer the payload to the second security domain.

2. The system of claim 1, wherein the operations further comprise:
generating, based on the extracted metadata, an ordered list that identifies multiple different CDSs, wherein the first CDS is selected from the generated order list and is the CDS, of the multiple different CDS, that is highest in priority within the order list.

3. The system of claim 2, wherein the operations further comprise:
determining that the first CDS has failed to transfer the payload to the second security domain; and
based on determination that the first CDS has failed to transfer the payload, automatically selecting, for the ordered list, a second CDS that is different from the first CDS; and
attempting to transfer the payload using the second CDS.

4. The system of claim 3, wherein results of at least one preprocessing operation performed for the first CDS are used for the attempted transfer of the payload using the second CDS.

5. The system of claim 2, wherein an attempt with each of the CDSs in the generated list is made until transfer of the payload is successful.

6. The system of claim 2, wherein the ordered list is additionally based on which CDSs of the plurality of CDSs a requestor is authorized to use.

7. The system of claim 1, wherein the operations further comprise:
monitoring for a result state of the transfer of the payload by the first CDS.

8. The system of claim 1, wherein the operations further comprise:
prompting an approver to approve the request to transfer the payload to the second security domain, wherein the instruction to the first CDS is additionally conditioned on approval of the request by the approver.

9. The system of claim 1, wherein the operations further comprise:
generating and signing a manifest that includes results of antivirus and/or malware scanning.

10. The system of claim 9, wherein the instruction to the first CDS to transfer the payload is additionally conditioned upon the manifest.

11. The system of claim 9, wherein the instruction to the first CDS to transfer the payload occurs prior to generation and signing of the manifest that includes results of antivirus and/or malware scanning.

12. The system of claim 1, further comprising:
a second processing system that is provided within the second security domain, the second processing system comprising instructions stored to non-transitory memory, the instructions configured to cause at least one hardware processor of the second processing system to perform operations comprising:
monitoring for reception of the payload; and
validating the payload by generating a hash of the payload that has been received and comparing the hash to a provided hash.

13. A method implemented on a security domain that is configured to interface with a plurality of different cross domain solutions (CDS), the method comprising:
receiving a request to transfer a payload from the security domain to a second security domain;
extracting metadata based on the payload;
automatically selecting, based at least in part on the extracted metadata, a first CDS, out of a plurality of CDSs, to carry out the transfer of the payload from the security domain to the second security domain;
based on which one of the plurality of CDSs was selected as the first CDS, performing one or more preprocessing operations on the payload; and
based at least in part on the performed one or more preprocessing operations, instructing the first CDS to transfer the payload to the second security domain.

14. The method of claim 13, further comprising:
generating, based on the extracted metadata, an ordered list that identifies multiple different CDSs, wherein the first CDS is selected from the generated order list and is the CDS, of the multiple different CDS, that is highest in priority within the order list.

15. The method of claim 14, further comprising:
determining that the first CDS has failed to transfer the payload to the second security domain; and
based on determination that the first CDS has failed to transfer the payload, automatically selecting, for the ordered list, a second CDS that is different from the first CDS; and
attempting to transfer the payload using the second CDS.

16. The method of claim 15, wherein results of at least one preprocessing operation performed for the first CDS are used for the attempted transfer of the payload using the second CDS.

17. The method of claim 13, further comprising:
prompting an approver to approve the request to transfer the payload to the second security domain, wherein the instruction to the first CDS is additionally conditioned on approval of the request by the approver.

18. The method of claim 13, further comprising:
generating and signing a manifest that includes results of antivirus and/or malware scanning.

19. The method of claim 18, wherein the instruction to the first CDS to transfer the payload occurs prior to generation and signing of the manifest that includes results of antivirus and/or malware scanning.

20. A non-transitory computer readable storage medium storing computer executable instructions for use with at least one hardware processor of a processing system of a first security domain, the stored instructions comprising instructions configured to cause the at least one hardware processor to perform operations comprising:
receiving a request to transfer a payload from the security domain to a second security domain;
extracting metadata based on the payload;
automatically selecting, based at least in part on the extracted metadata, a first CDS, out of a plurality of CDSs, to carry out the transfer of the payload from the first security domain to the second security domain;
based on which one of the plurality of CDSs was selected as the first CDS, performing one or more preprocessing operations on the payload; and
based at least in part on the performed one or more preprocessing operations, instructing the first CDS to transfer the payload to the second security domain.
